(19) United States
(12) Patent Application Publication
(10) Pub. No.: US 2025/0025863 A1
(43) Pub. Date: Jan. 23, 2025

(54) METHODS AND SYSTEMS FOR PREPARATION OF A PHOSPHATE MODIFIED ZEOLITE CATALYST

(71) Applicant: SABIC Global Technologies B.V., Bergen OP Zoom (NL)

(72) Inventors: Vidya Sagar Guggilla, Bangalore (IN); Wojciech Supronowicz, Riyadh (SA); Ahmed S. Al-Zenaidi, Riyadh (SA)

(21) Appl. No.: 18/717,647

(22) PCT Filed: Dec. 15, 2022
(86) PCT No.: PCT/IB2022/062315

§ 371 Date: Jun. 7, 2024

Related U.S. Application Data
(60) Provisional application No. 63/265,457, filed on Dec. 15, 2021.

(51) Int. Cl. B01J 29/40; B01J 37/00; C10G 11/05

(52) U.S. Cl. CPC B01J 29/40; B01J 37/0045; C10G 11/05; C10G 2400/20; C10G 2400/22

(57) ABSTRACT

Provided here are methods and systems for preparing a solid supported modified zeolite catalyst for use in the fluid catalytic cracking of a hydrocarbon feedstock, a such as a feedstock with a boiling point of less than 330° C. Methods include preparing an alkaline treated zeolite, passivating by phosphatation, and combining with alumina and silica slurry to result in a spray dryable catalyst precursor. The spray dried modified zeolite catalyst can be used in a fluid catalytic cracking unit to convert light hydrocarbon feedstocks to ethylene and propylene enriched product streams.

### CROSS-REFERENCE TO RELATED APPLICATIONS

This application claims priority to and the benefit of U.S. Provisional Application No. 63/265,457, filed Dec. 15, 2021. The contents of the referenced application are incorporated into the present application by reference.

### TECHNICAL FIELD

The present disclosure generally relates to methods and systems for producing a phosphate modified zeolite catalyst. The disclosure also relates to the use of this modified catalyst as cracking catalyst in a fluid catalytic cracker to produce a high value chemical product from a light hydrocarbon fluid.

### BACKGROUND

Hydrocarbon liquids are a feedstream for cracking units to produce high value products such as ethylene, propylene, butenes, benzene, toluene, and xylenes. Hydrocarbon liquids come from a multitude of sources, like heavy gas oil and mixed plastic waste, in which the components are long chain hydrocarbons having a density of 600 Kg/m³ to 800 kg/m³ with boiling points at atmospheric pressure of over 350° C. The per pass yield of high value chemicals is low given the broad assortment of cracked products that can be formed. Additionally, the carbon to hydrogen ratio of long chain hydrocarbons is conducive to coke formation on and within the cracking catalyst. To improve the yield of high value products, the low value products are recycled within a fluid catalytic cracking (FCC) unit or subjected to further cracking operations, like steam cracking (SC), hydrocracking (HC), hydrotreating (HT), or naphtha hydrotreating (NHDT). An alternative option for cracker operators is to use lighter hydrocarbon feeds, like naphtha, gas condensates, or pyrolysis oils, either singly or in combination. These lighter hydrocarbons have been historically cracked using steam cracking, but fluid catalytic cracking, which may be more efficient, is possible when an appropriate catalyst is used. The challenge has been identifying a catalyst to provide a high yield of high value chemical products, especially ethylene and propylene.

### SUMMARY

Embodiments include methods of preparing a modified zeolite catalyst. One such method includes introducing a HZSM-5 zeolite to a milling unit to produce a milled HZSM-5 zeolite with a particle size of less than about 2 microns. The method further includes introducing the milled HZSM-5 zeolite to an aqueous alkaline solution to make an alkali treated HZSM-5 (AT-HZSM-5) zeolite. In certain embodiments, the aqueous alkaline solution contains a potassium hydroxide, a lithium hydroxide, or a sodium hydroxide. The method further includes adding a phosphatation agent in a first predetermined amount to the AT-HZSM-5 zeolite to produce a first phosphate treated AT-HZSM-5 zeolite containing about 5 weight percent of phosphorous pentoxide (5 wt. % P₂O₅-AT-HZSM-5 zeolite), followed by introducing the 5 wt. % P₂O₅-AT-HZSM-5 zeolite to a mixture of an aqueous clay slurry and an alumina dispersion to produce a mixed zeolite binder slurry. The method also includes adding the phosphatation agent in a second predetermined amount to the mixed zeolite binder slurry to produce a second phosphate treated AT-HZSM-5 zeolite containing about 10 weight percent of phosphorous pentoxide (10 wt. % P₂O₅-AT-HZSM-5 zeolite), followed by agitating the 10 wt. % P₂O₅-AT-HZSM-5 zeolite to produce a homogenized zeolite slurry. In certain embodiments, agitating the 10 wt. % P₂O₅-AT-HZSM-5 zeolite includes ultrasonication for a period of about 30 minutes. The method also includes passing the homogenized zeolite slurry through a spray dryer to produce spherical particles of the modified HZSM-5 zeolite catalyst. The modified HZSM-5 zeolite catalyst has a particle size distribution centered between about 60 microns to about 120 microns and a bulk density ranging from about 0.7 g/ml to about 0.95 g/ml.

In certain embodiments, the alumina dispersion includes alumina in the form of pseudo boehmite, pseudo boehmite SCF, dispersal alumina, or alumina sol. In certain embodiments, the clay is one or more of a kaolin, a halloysite, a montmorillonite, a diatomite, an attapulgite, a sepiolite, a hydrotalcite, a rectorite, or a bentonite. In certain embodiments, the phosphatation agent is a phosphoric acid, a monoammonium phosphate, an ammonium hydrogen phosphate, or an ammonium phosphate. In certain embodiments, the phosphatation agent is a suitable phosphate-based compound that can increase the weight percent of phosphorous pentoxide of the phosphate treated AT-HZSM-5 zeolite.

In certain embodiments, the method also includes the preparation of the alumina dispersion by treating an alumina with an aqueous nitric acid, an aqueous acetic acid, or an aqueous formic acid solution for a pre-determined time period. The alumina can be subject to the acid treatment for about three hours to disperse or peptize the alumina in the water phase.

In certain embodiments, the method further includes the step of subjecting the 5 wt. % P₂O₅-AT-HZSM-5 zeolite to calcination for a period ranging from about 30 minutes to about 10 hours at a temperature ranging from about 300° C. to about 650° C. In certain embodiments, the method includes the step of subjecting the 10 wt. % P₂O₅-AT-HZSM-5 zeolite to calcination for a period ranging from about 30 minutes to about 10 hours at a temperature ranging from about 300° C. to about 650° C. In certain embodiments, the method also includes the step of subjecting the modified HZSM-5 zeolite catalyst to calcination for a period ranging from about 30 minutes to about 10 hours at a temperature ranging from about 300° C. to about 650° C.

Certain embodiments of the methods of preparing a high value chemical product using a modified HZSM-5 zeolite catalyst include the steps of supplying a modified HZSM-5 zeolite catalyst to a cracking unit, followed by introducing a hydrocarbon fluid to the modified HZSM-5 zeolite catalyst. The hydrocarbon fluid contains a plurality of hydrocarbons containing less than about 24 carbon atoms. The method also includes causing catalytic cracking of the one or more of the hydrocarbons in the hydrocarbon fluid to produce a hydrocarbon product stream containing a plurality of alkene hydrocarbons and aromatics ranging from about 2 carbon atoms to about 10 carbon atoms, and supplying the hydrocarbon product stream to a separator to produce a high value chemical product. The high value chemical product is one or more of ethylene, propylene, butenes, benzene, toluene, and xylenes. In certain embodiments, the method further includes separating the hydrocarbon product stream by distillation to produce the high value chemical product. In certain embodiments, the method also includes recycling the high value chemical products back to the cracking unit to achieve a specific product profile.

Embodiments include systems for preparing a high value chemical product using a modified HZSM-5 zeolite catalyst. One such system includes (i) a milling unit equipped to receive a HZSM-5 zeolite powder and operated to produce a milled HZSM-5 zeolite powder with a particle size of less than about 2 microns, (ii) a first mixing unit equipped to receive the milled HZSM-5 zeolite powder, an aqueous alkaline solution, and a first phosphatation agent in a first predetermined amount, and operated to mix the foregoing to produce a first phosphate treated AT-HZSM-5 zeolite containing about 5 weight percent of phosphorous pentoxide, (iii) a second mixing unit equipped to receive a clay powder and deionized water and operated to mix the foregoing to produce an aqueous clay slurry, (iv) a third mixing unit equipped to receive an alumina powder and an aqueous acidic solution and operated to mix the foregoing to produce an alumina dispersion, (v) a fourth mixing unit equipped to receive the clay slurry and the alumina dispersion and operated to mix the foregoing to produce a mixed binder slurry, (vi) a fifth mixing unit equipped to receive the first phosphate treated AT-HZSM-5 zeolite, the mixed binder slurry, and a second phosphatation agent in a second predetermined amount, and operated to mix the first phosphate treated AT-HZSM-5 zeolite, the mixed binder slurry, and a second phosphatation agent in a second predetermined amount to produce a second phosphate treated AT-HZSM-5 zeolite containing about ten weight percent of phosphorus pentoxide, (vii) a sixth mixing unit containing an agitator and equipped to receive the second phosphate treated AT-HZSM-5 zeolite, the agitator being operated to produce a homogenized zeolite slurry, and (viii) a spray dryer equipped to receive the homogenized zeolite slurry and operated to produce spherical particles of a modified HZSM-5 zeolite catalyst.

In certain embodiments, a mixing unit can consist of one unit, multiple units or a plurality of subunits. In certain embodiments, a single mixing unit can perform the functions of two or more mixing units of the system. In certain embodiments, agitation of the second phosphate treated AT-HZSM-5 zeolite involves ultrasonication for a period of about 30 minutes. In certain embodiments, the modified HZSM-5 zeolite catalyst has a particle size distribution centered between about 60 microns to about 120 microns and a bulk density of between about 0.7 g/ml to about 0.95 g/ml.

In certain embodiments, the aqueous alkaline solution is a potassium hydroxide, a lithium hydroxide, or a sodium hydroxide. In certain embodiments, the first or second phosphatation agent is a phosphoric acid, a monoammonium phosphate, an ammonium hydrogen phosphate, or an ammonium phosphate. In certain embodiments, the clay powder is one or more of a kaolin, a halloysite, a montmorillonite, a diatomite, an attapulgite, a sepiolite, a hydrotalcite, a rectorite, or a bentonite. In certain embodiments, the alumina dispersion is prepared by treating an alumina with an aqueous nitric acid, an aqueous acetic acid, or an aqueous formic acid solution for about three hours to disperse the alumina in the water phase. In certain embodiments, the aqueous clay slurry is prepared by mixing the clay with a deionized water for about three hours.

In certain embodiments, the system includes a fluid catalyst cracking unit equipped to receive the modified HZSM-5 zeolite catalyst from the spray dryer and a hydrocarbon fluid made up of a plurality of hydrocarbons containing from about less than about 24 carbon atoms and operated to produce a high value chemical product containing ethylene, propylene, butenes, benzene, toluene, and xylenes. In certain embodiments, the hydrocarbon fluid contains hydrocarbons with a boiling point of less than about 330° C.

In certain embodiments, the system further includes a calcining unit equipped to receive the modified HZSM-5 zeolite catalyst and operated to produce a calcined modified HZSM-5 zeolite catalyst product. In certain embodiments, the calcining unit is operated for a period ranging from about 30 minutes to about 10 hours at a temperature ranging from about 300° C. to about 650° C.

Embodiments include a fluid catalytic cracking catalyst containing a mesoporous HZSM-5 zeolite in an amount ranging from about 20 wt. % to about 55 wt. % f the fluid catalytic cracking catalyst, a phosphorous oxide in an amount from 5 wt. % to about 15 wt. % P₂O₅ of the fluid catalytic cracking catalyst, an alumina binder in an amount from about 20 wt. % to about 30 wt. % of the fluid catalytic cracking catalyst, a clay in an amount from about 30 wt. % to about 40 wt. % of the fluid catalytic cracking catalyst; and a sodium ion in an amount greater than about 0.1 wt. % of the fluid catalytic cracking catalyst.

Aspects and advantages of these exemplary embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1 is diagrammatic representation of a method of modifying a HZSM-5 zeolite by milling, alkali treatment, phosphatation, followed by combination with a binder mixture and additional phosphatation. The resulting slurry is subject to ultrasonication and then spray dried to produce spherical particles of a modified HZSM-5 zeolite catalyst.

FIG. 2 is a diagrammatic representation of a method of using a spherical particle modified HZSM-5 zeolite catalyst in a cracking unit to produce a high value chemical product from a light hydrocarbon fluid.

FIG. 3 is a diagrammatic representation of a system with a milling unit, a first mixing unit, a second mixing unit, a third mixing unit, a fourth mixing unit, a fifth mixing unit, an ultrasonication unit, a spray dryer unit, and a cracking unit to produce a modified HZSM-5 catalyst and its use for catalytic cracking of a light hydrocarbon fluid to produce a high value chemical product.

### DETAILED DESCRIPTION

The present disclosure describes various embodiments related to compositions, methods, and systems for the preparation of a modified HZSM-5 zeolite catalyst for use in catalytic cracking of hydrocarbon fluids, such as light hydrocarbon fluids. The modified HZSM-5 zeolite catalyst can provide several advantages. One advantage is the increased catalytic activity of the modified HZSM-5 zeolite catalyst when compared to other Na+ ZSM-5 catalysts. Sodium is generally viewed as a contaminant in ZSM-5 cracking catalysts as it alters the acidity of the catalyst, leads to a preference in paraffin production, and an overall lower yield of high value chemical products. Other advantages include lower attrition losses for the spray dried spherical particles, that is the reduction of particle size through particle motion and inter-particle interactions. In certain embodiments, the attrition loss is expressed as a dimensionless ratio. In certain embodiments, the modified HZSM-5 zeolite catalyst has an attrition loss of less than 10 or even less than 7. Another advantage of the modified HZSM-5 zeolite catalyst is its hydrothermal stability, which permits the elimination of a hydrothermal treatment step in the form of steam treating of the phosphate-modified zeolite. Steam treating can have the effect of removing aluminum from the framework and lead to a loss in weak acid sites and a gain in strong acid sites. However, total acidity and catalyst activity of the modified HZSM-5 zeolite catalyst may remain the same with or without steam treating. Certain embodiments of the methods do not include this processing step, which may improve overall catalyst formation costs and reliability. Another advantage of the modified HZSM-5 zeolite catalyst is the ability to perform the cracking operations via fluid catalytic cracking, which may be more efficient than thermal cracking (e.g., steam cracking) or catalytic steam cracking. Another advantage of the modified HZSM-5 zeolite catalyst is the increased yield of high value short chain olefins, such as ethylene and propylene. It is generally reported that the per pass yield of ethylene plus propylene from light hydrocarbon fluid cracking is about 30 wt. % to 40 wt. %. In certain embodiments, the modified HZSM-5 zeolite catalyst per pass yield of ethylene and propylene is at least 32 wt. %.

The methods described herein allow for a simpler preparation of a highly active, high bulk density, spherical particle cracking catalyst for hydrocarbon fluid valorization. Further embodiments may be described and disclosed. In the following description, numerous details are set forth in order to provide a thorough understanding of the various embodiments. In other instances, well-known processes, devices, and systems may not have been described in particular detail in order not to unnecessarily obscure the various embodiments. Additionally, illustrations of the various embodiments may omit certain features or details in order to not obscure the various embodiments.

The description may use the phrases “in certain embodiments,” “in various embodiments,” “in an embodiment,” or “in embodiments,” which may each refer to one or more of the same or different embodiments. Furthermore, the terms “comprising,” “including,” “having,” and the like, as used with respect to embodiments of the present disclosure, are synonymous. The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “removing,” “removed,” “reducing,” “reduced,” or any variation thereof, when used in the claims and/or the specification includes any measurable decrease of one or more components in a mixture to achieve a desired result. The use of the words “a” or “an” when used in conjunction with any of the terms “comprising,” “including,” “containing,” or “having,” in the claims or the specification may mean “one,” but it is also consistent with the meaning of “one or more,” “at least one,” and “one or more than one.” The term “plurality” as used herein refers to two or more items or components. The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % f component.

Embodiments of methods, systems, and compositions described here are utilized to convert a hydrocarbon fluid to a high value chemical product using fluid catalytic cracking (FCC). The modified HZSM-5 zeolite catalyst can provide an improved yield of high value chemicals when compared to conventional FCC catalyst compositions or conventional catalytic steam cracking catalyst compositions. Below, discussion will generally describe certain embodiments of methods for producing the modified HZSM-5 zeolite catalyst, certain embodiments of methods for utilizing the modified HZSM-5 zeolite catalyst for FCC, and then certain systems for producing and/or utilizing the modified HZSM-5 zeolite catalyst.

In certain embodiments, a zeolite is milled with a milling unit to physically reduce the zeolite to a suitably small particle size, such as a particle size of less than 2 microns. In certain embodiments, the zeolite is initially provided with a suitable particle size. In certain embodiments, the zeolite is treated with an aqueous alkaline solution. The aqueous alkaline solution can contain a potassium hydroxide, lithium hydroxide, sodium hydroxide or combinations thereof. In certain embodiments, the acidity of the zeolite is altered by changing the silica to alumina ratio of the zeolite. In certain embodiments, the zeolite is treated with an aqueous alkaline solution to produce an alkali treated zeolite with a silica to alumina ratio of between about 10 to about 50. In certain embodiments, the zeolite is treated with an aqueous alkaline solution to produce an alkali treated zeolite with a silica to alumina ratio of between about 14 to about 25. In certain embodiments, the zeolite is treated with an aqueous alkaline solution to produce an alkali treated zeolite with a silica to alumina ratio of about 20. In certain embodiments, the acidity of the zeolite is altered by complexing a counterion with an acid site of the zeolite. In certain embodiments, the alkali treated zeolite is not subject to a counterion exchange to remove the potassium, lithium, or sodium counterion prior to further processing.

In certain embodiments, the zeolite is a ZSM-5, ZSP, or ZRP zeolite. In certain embodiments, the zeolite is a neutral form of ZSM-5, ZSP, or ZRP zeolite. In certain embodiments, the zeolite is a hydrogen form of ZSM-5, ZSP, or ZRP zeolite. In certain embodiments, a HZSM-5 zeolite is treated with an aqueous alkaline solution to produce an alkali treated HZSM-5 (AT-HZSM-5) zeolite with a silica to alumina ratio of between about 14 to about 25. In certain embodiments, a HZSM-5 zeolite is treated with an aqueous alkaline solution to produce an alkali treated HZSM-5 (AT-HZSM-5) zeolite with a silica to alumina ratio of about 20. In certain embodiments, the AT-HZSM-5 zeolite is not subject to a counterion exchange to remove the potassium, lithium, or sodium counterion. In certain embodiments, the AT-HZSM-5 zeolite is calcined for a period ranging from about 30 minutes to about 10 hours at a temperature ranging from about 300° C. to about 650° C.

In certain embodiments, the mixing of the HZSM-5 zeolite with an aqueous alkaline solution produces a slurry. In certain embodiments, the mixing of the HZSM-5 zeolite with an aqueous alkaline solution produces a slurry which is stabilized by the inclusion of surface active additives. In certain embodiments, the mixing of the HZSM-5 zeolite with an aqueous alkaline solution produces a slurry containing HZSM-5 zeolite solids of between about 20 wt. % to about 50 wt. %.

In certain embodiments, phosphatation is used to improve the hydrothermal stability of the zeolite. Certain embodiments include performing two separate phosphatations on the zeolite to further improve the hydrothermal stability thereof such that steam treating may be eliminated. In certain embodiments, phosphatation is used to decrease the number of strong acid sites and the framework negative charge of the zeolite. In certain embodiments, the phosphatation agent is at least one of a phosphoric acid, a monoammonium phosphate, an ammonium hydrogen phosphate, or an ammonium phosphate. In certain embodiments, the phosphatation agent is a suitable phosphate-based compound that can increase the weight percent of phosphorous pentoxide of the phosphate treated AT-HZSM-5 zeolite. In certain embodiments, the AT-HZSM-5 zeolite is treated with a phosphatation agent in an amount to produce about a 5 wt. % P₂O₅-AT-HZSM-5 zeolite. In certain embodiments, the alkali treated zeolite is treated with a first phosphatation agent to produce a first phosphate treated P₂O₅-AT-HZSM-5 zeolite with a P₂O₅ wt. % f between about 1 wt. % and about 5 wt. %. In certain embodiments, the 5 wt. % P₂O₅-AT-HZSM-5 zeolite is calcined for a period ranging from about 30 minutes to about 10 hours at a temperature ranging from about 300° C. to about 650° C. In certain embodiments, the first phosphate treated P₂O₅-AT-HZSM-5 zeolite is calcined for a period ranging from about 30 minutes to about 10 hours at a temperature ranging from about 300° C. to about 650° C.

In certain embodiments, the 5 wt. % P₂O₅-AT-HZSM-5 zeolite is added to a mixture of dispersed alumina and clay slurry to produce a mixed zeolite binder slurry. In certain embodiments, the first phosphate treated AT-HZSM-5 zeolite is added to a mixture of dispersed alumina and clay slurry to produce a mixed zeolite binder slurry. In certain embodiments, the 5 wt. % P₂O₅-AT-HZSM-5 zeolite, dispersed alumina, and clay slurry is treated with a phosphatation agent in an amount to produce about a 10 wt. % P₂O₅-AT-HZSM-5 zeolite. In certain embodiments, the first phosphate treated AT-HZSM-5 zeolite, dispersed alumina, and clay slurry is treated with a second phosphatation agent to produce a second phosphate treated AT-HZSM-5 zeolite with a P₂O₅ wt. % f between about 5 wt. % and about 10 wt. %. In certain embodiments, the first phosphatation agent and the second phosphatation agent are the same or different. In certain embodiments discussed throughout, the dispersed alumina may be peptized pseudo boehmite.

In certain embodiments, the 5 wt. % P₂O₅-AT-HZSM-5 zeolite is treated with a phosphatation agent in an amount to produce about a 10 wt. % P₂O₅-AT-HZSM-5 zeolite. In certain embodiments, the first phosphate treated AT-HZSM-5 zeolite is treated with a second phosphatation agent to produce a second phosphate treated AT-HZSM-5 zeolite with a P₂O₅ wt. % of between about 5 wt. % and about 10 wt. %. In certain embodiments, the about a 10 wt. % P₂O₅-AT-HZSM-5 zeolite is added to a mixture of a dispersed alumina and a clay slurry. In certain embodiments, the second phosphate treated AT-HZSM-5 zeolite with a P₂O₅ wt. % f between about 5 wt. % and about 10 wt. % is added to a mixture of a dispersed alumina and a clay slurry. In certain embodiments, a phosphatation agent is added to a mixture of a dispersed alumina and a clay slurry such that the subsequent addition of the 5 wt. % P₂O₅-AT-HZSM-5 zeolite will treat the 5 wt. % P₂O₅-AT-HZSM-5 zeolite to produce a 10 wt. % P₂O₅-AT-HZSM-5 zeolite.

In certain embodiments, the 10 wt. % P₂O₅-AT-HZSM-5 zeolite is calcined for a period ranging from about 30 minutes to about 10 hours at a temperature ranging from about 300° C. to about 650° C. In certain embodiments, the second phosphate treated AT-HZSM-5 zeolite is calcined for a period ranging from about 30 minutes to about 10 hours at a temperature ranging from about 300° C. to about 650° C.

In certain embodiments, the 10 wt. % P₂O₅-AT-HZSM-5 zeolite is subjected to agitation to produce a homogenized zeolite slurry that is free of aggregated or associated particles. In certain embodiments, the second phosphate treated AT-HZSM-5 zeolite is subjected to agitation to produce a homogenized zeolite slurry free of aggregated or associated particles. In certain embodiments, the agitation is ultrasonication or mechanical wet milling. In certain embodiments, agitation is performed within the same mixing unit as the preparation of the 10 wt. % P₂O₅-AT-HZSM-5 zeolite. In certain embodiments, agitation is performed within the same mixing unit as the preparation of the second phosphate treated AT-HZSM-5 zeolite. In certain embodiments, the agitation is performed in a separate unit.

In certain embodiments, the homogenized zeolite slurry is dispersed within the spray dryer by an atomizer or nozzle, and then dried to produce a modified HZSM-5 zeolite catalyst. In certain embodiments, the atomizer is a spinning disk configured to atomize the homogenized zeolite slurry to a droplet size of less than about 200 microns. In certain embodiments, the nozzle is a high pressure swirl nozzle or ultrasonic nozzle configured to atomize the homogenized zeolite slurry to a droplet size of less than about 200 microns. In certain embodiments, the modified HZSM-5 zeolite has a catalyst particle size distribution centered between about 60 microns to about 200 microns. In certain embodiments, the modified HZSM-5 zeolite catalyst particle size distribution is monodisperse with a polydispersity value of less than about 0.1. In certain embodiments, the modified HZSM-5 zeolite catalyst particle size distribution is polydisperse with a polydispersity value between about 0.1 to about 1. In certain embodiments, the modified HZSM-5 zeolite catalyst has a bulk density between about 0.5 g/ml to about 1.2 g/ml. In certain embodiments, the modified HZSM-5 zeolite catalyst has a bulk density between about 0.7 g/ml to about 0.95 g/ml. In certain embodiments, the modified HZSM-5 zeolite catalyst has a bulk density between about 0.7 g/ml to about 1.2 g/ml. In certain embodiments, the modified HZSM-5 zeolite catalyst has a uniform particle distribution. In certain embodiments, the modified HZSM-5 zeolite catalyst has a non-uniform particle distribution. In certain embodiments, the fluid catalytic cracking catalyst contains a mesoporous HZSM-5 zeolite in an amount ranging from about 20 wt. % to about 60 wt. %. In certain embodiments, the mesoporous HZSM-5 zeolite contains about 10 wt. % f phosphorous pentoxide. In certain embodiments, the fluid catalytic cracking catalyst contains a mesoporous HZSM-5 zeolite in an amount ranging from about 20 wt. % to about 55 wt. %. In certain embodiments, the fluid catalytic cracking catalyst contains a mesoporous HZSM-5 zeolite in an amount ranging from about 20 wt. % to about 40 wt. %. In certain embodiments, the modified HZSM-5 zeolite catalyst is calcined for a period ranging from about 30 minutes to about 10 hours at a temperature ranging from about 300° C. to about 650° C.

In certain embodiments, the hydrocarbon fluid to be cracked with the modified HZSM-5 zeolite catalyst is a light hydrocarbon fluid. In certain embodiments, the hydrocarbon fluid is a mixture of hydrocarbon compounds with boiling points less than about 330° C. In certain embodiments, the hydrocarbon fluid is a mixture of hydrocarbon compounds with boiling points between about 200° C. and about 330° C. In certain embodiments, the hydrocarbon fluid is a mixture of hydrocarbon compounds that are less than about 24 carbon atoms. In certain embodiments, the hydrocarbon fluid is a pyrolysis oil made from mixed plastic waste. In certain embodiments, the hydrocarbon fluid is a pyrolysis oil made from recycled plastic waste. In certain embodiments, the hydrocarbon fluid is a naphtha or gas condensate. In certain embodiments, the hydrocarbon fluid is a mixture of hydrocarbon compounds with between about 4 carbon atoms to about 20 carbon atoms. In certain embodiments, the hydrocarbon fluid includes sulfur-containing organic compounds between 0 and 100 ppm. In certain embodiments, the hydrocarbon fluid includes nitrogen-containing organic compounds between 0 ppm and 50 ppm. The hydrocarbon fluid may exclude oxygenated compounds, in certain embodiments. Specific, non-limiting examples of certain hydrocarbon fluids are provided below in the Example section. Moreover, in certain embodiments, the hydrocarbon product stream is subject to recycling within the FCC unit or additional subsequent cracking.

In certain embodiments, the aqueous clay slurry is prepared by mixing at least one of a kaolin, a halloysite, a montmorillonite, a diatomite, an attapulgite, a sepiolite, a hydrotalcite, a rectorite, or a bentonite with a deionized water for about three hours. In certain embodiments, the clay slurry aggregates and associated particles are disintegrated or deaggregated by ultrasonication or mechanical wet milling. In certain embodiments, the clay is suspended in the water phase by the addition of surface active additives. In certain embodiments, the alumina dispersion is prepared by treating an alumina with an aqueous nitric acid, an aqueous acetic acid, or an aqueous formic acid for about three hours to disperse the alumina in the water phase. In certain embodiments, the alumina dispersion is a peptization prepared by treating a pseudo boehmite with an aqueous nitric acid, an aqueous acetic acid, or an aqueous formic acid for about three hours to disperse the pseudo boehmite in the water phase.

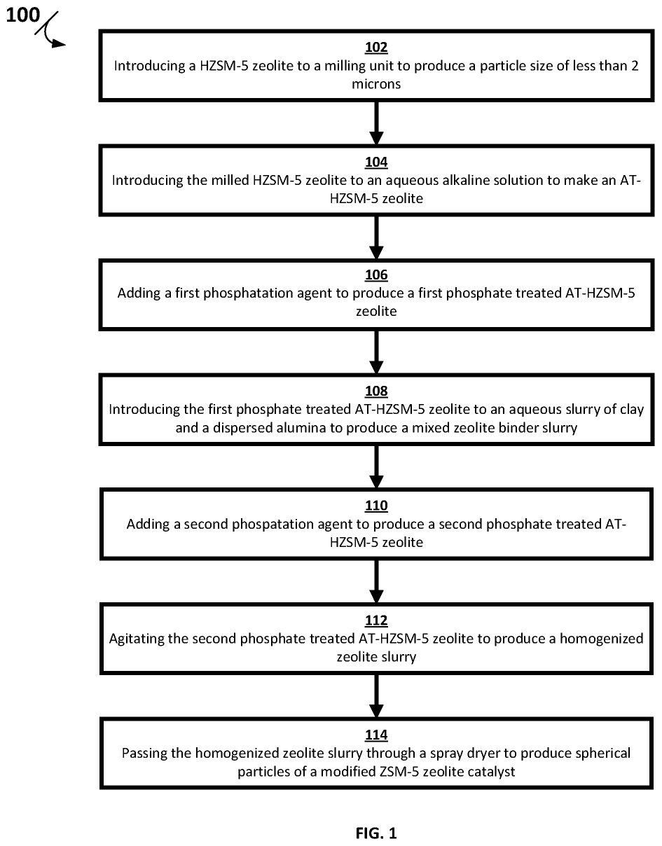

FIG. 1 is diagrammatic representation of a method 100 to produce a modified HZSM-5 zeolite catalyst. This method includes the step 102 of introducing a HZSM-5 zeolite to a milling unit to produce a milled HZSM-5 zeolite with a particle size of less than 2 microns. In certain embodiments, the milling unit is a ball mill or a jet mill. In a subsequent step 104, the milled HZSM-5 zeolite is introduced to a mixing unit and mixed with an aqueous alkaline solution to produce an alkali treated HZSM-5 (AT-HZSM-5) zeolite. In certain embodiments, the aqueous alkaline solution is at least one of a potassium hydroxide, a lithium hydroxide, or a sodium hydroxide. In certain embodiments, the method also includes subjecting the AT-HZSM-5 zeolite to calcination for a period ranging from about 30 minutes to about 10 hours at a temperature from about 300° C. to about 650° C.

The method also includes the step 106 of adding a first predetermined amount of a phosphatation agent to the AT-HZSM-5 zeolite to produce a first phosphate treated AT-HZSM-5 zeolite containing about 5 wt. % f phosphorus pentoxide (5%-P₂O₅-AT-HZSM-5 zeolite). In certain embodiments, the phosphatation agent is at least one of a monoammonium phosphate, an ammonium hydrogen phosphate, or an ammonium phosphate. In certain embodiments, a first manner of preparing the first phosphate treated AT-HZSM-5 zeolite includes: preparing a first solution including a predetermined amount of the AT-HZSM-5 zeolite dispersed in a deionized water; and preparing a second solution including a predetermined amount of a 5 wt. % P₂O₅ equivalent monoammonium di-hydrogen phosphate dissolved in deionized water. Then, the first solution and the second solution are mixed with one another to form a slurry stabilized at room temperature via continuous stirring for about three hours, with a pH that is maintained at or above 3, to form a first slurry with the 5%-P₂O₅-AT-HZSM-5 zeolite.

In certain embodiments, an alternative, second manner of preparing the first phosphate treated AT-HZSM-5 zeolite includes dissolving a predetermined amount of 5 wt. % P₂O₅ equivalent monoammonium di-hydrogen phosphate in deionized water and impregnating the same onto a predetermined amount of the AT-HZSM-5 zeolite. In certain embodiments, the method also includes subjecting the 5%-P₂O₅-AT-HZSM-5 zeolite to calcination for a period ranging from about 30 minutes to about 10 hours at a temperature from about 300° C. to about 650° C. In certain embodiments, the calcination is performed at 550° C. for about 3 hours. The resulting powder is added to a deionized water to form a first slurry with the 5%-P₂O₅-AT-HZSM-5 zeolite.

The method includes the step 108 of introducing the 5%-P₂O₅-AT-HZSM-5 zeolite to a mixture of an aqueous clay slurry and an alumina dispersion to produce a mixed zeolite binder slurry. In certain embodiments, the aqueous clay slurry is prepared by mixing at least one of a kaolin, a halloysite, a montmorillonite, a diatomite, an attapulgite, a sepiolite, a hydrotalcite, a rectorite, or a bentonite with a deionized water for about three hours. In certain embodiments, the alumina dispersion is prepared by treating an alumina with an aqueous nitric acid, an aqueous acetic acid, or an aqueous formic acid for about three hours to disperse the alumina in the water phase. In certain embodiments, the alumina dispersion is a peptization of pseudo boehmite in the water phase. In certain embodiments, the alumina dispersion includes a predetermined amount of dispersal P2 grade alumina added to a deionized water, peptized with nitric acid, and maintained at a pH of 3 or higher.

The method also includes the step 110 of adding a second predetermined amount of a phosphatation agent to the AT-HZSM-5 zeolite to produce a second phosphate treated AT-HZSM-5 zeolite containing about 10 wt. % f phosphorus pentoxide (10%-P₂O₅-AT-HZSM-5 zeolite). In certain embodiments, producing the second phosphate treated AT-HZSM-5 zeolite includes dissolving a predetermined amount monoammonium di-hydrogen phosphate in deionized water via mixing for about three hours to form a second phosphatation agent slurry, which is mixed with the mixed zeolite binder slurry. In certain embodiments, the aqueous clay slurry and the alumina dispersion may be mixed first, then introduced to the second phosphatation agent slurry. In such embodiments, a slurry of the 5%-P₂O₅-AT-HZSM-5 zeolite may be added thereto under constant mixing to produce the second phosphate treated AT-HZSM-5 zeolite. In certain embodiments, the resulting slurry is maintained at a pH between 5 and 5. In certain embodiments, the pH is maintained about 3.5. In certain embodiments, the phosphatation agent is at least one of a phosphoric acid, a monoammonium phosphate, an ammonium hydrogen phosphate, or an ammonium phosphate. In certain embodiments, the method also includes subjecting the 10%-P₂O₅-AT-HZSM-5 zeolite to calcination for a period ranging from about 30 minutes to about 10 hours at a temperature from about 300° C. to about 650° C.

The method includes the step 112 of agitating the 10%-P₂O₅-AT-HZSM-5 zeolite to produce a homogenized zeolite slurry. In certain embodiments, the homogenized zeolite slurry is free of aggregated or associated particles. In certain embodiments, agitation includes ultrasonication for a period of about 30 minutes. In certain embodiments, agitation includes ultrasonication for a period of about 60 minutes.

The method also includes the step 114 of passing the homogenized zeolite slurry through the spray drying to produce spherical particles of a modified HZSM-5 zeolite catalyst. In certain embodiments, the homogenized zeolite slurry is heated to 50° C. under constant mixing before being passed through the spray drying. In certain embodiments, the spray dried modified HZSM-5 zeolite catalyst has a particle size distribution centered between about 60 microns and about 120 microns with a bulk density ranging from about 0.7 g/ml to about 0.95 g/ml. In certain embodiments, the spray dried modified HZSM-5 zeolite catalyst has an average particle size between about 80 microns and about 110 microns. In certain embodiments, the method also includes subjecting the modified HZSM-5 zeolite catalyst to calcination for a period ranging from about 30 minutes to about 10 hours at a temperature from about 300° C. to about 650° C. In certain embodiments, the calcination is performed for about 3 hours at about 650° C. As such, the method provides a final modified HZSM-5 zeolite catalyst that is a micro spheroidal 10% phosphorus stabilized, alkali treated (mesoporous) HZSM-5 catalyst. In certain embodiments, the resulting catalyst provides a measurable attrition loss that is less than 5 wt. % and an average particle size between about 60 microns and about 130 microns.

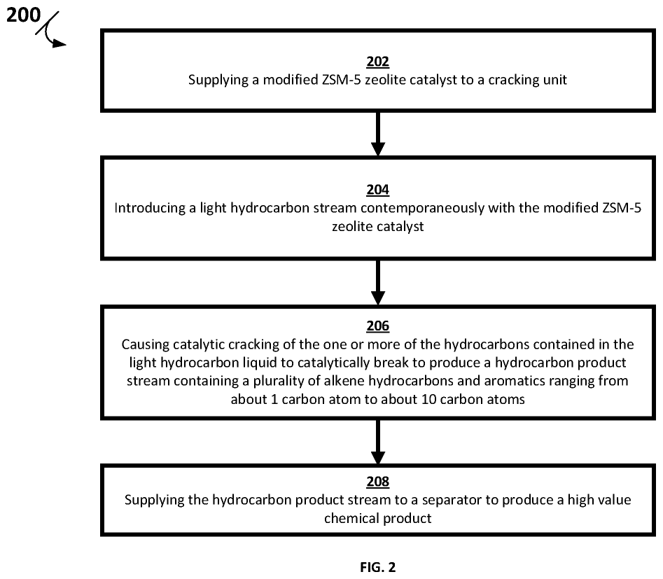

FIG. 2 is diagrammatic representation of a method 200 of preparing a high value chemical product using a modified HZSM-5 zeolite catalyst. The method includes the step 202 of supplying a modified HZSM-5 zeolite catalyst to a cracking unit. In certain embodiments, the cracking unit is a fluid cracking unit (FCC). The method further includes the step 204 of introducing a hydrocarbon fluid contemporaneously with the modified HZSM-5 zeolite catalyst. The method includes the step 206 of causing catalytic cracking of one or more hydrocarbons within the hydrocarbon fluid to produce a hydrocarbon product stream. The hydrocarbon product stream contains a plurality of alkene hydrocarbon and aromatics ranging from about 1 carbon atom to about 10 carbon atoms. In certain embodiments, the hydrocarbon fluid contains light hydrocarbons with a boiling point of less than about 330° C. The method also includes the step 208 of supplying the hydrocarbon product stream to a separator to produce the high value chemical product. In certain embodiments, the high value chemical product is composed of ethylene, propylene, butenes, benzene, toluene, and xylenes. In certain embodiments, the separator is a distillation unit, cryogenic separator, or molecular sieve.

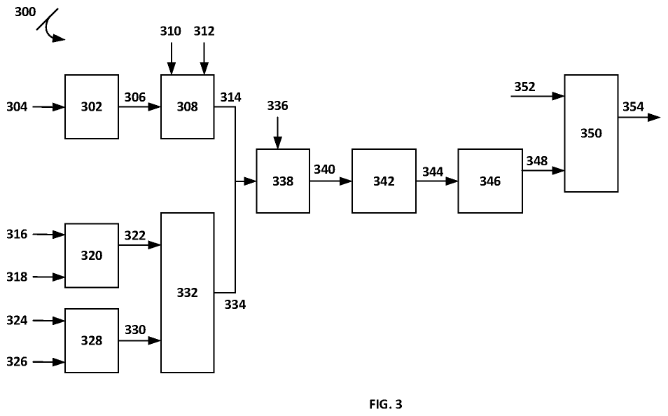

Embodiments also include systems for preparation of a modified HZSM-5 zeolite catalyst 348 and its use in cracking operations to produce a high value chemical product 354. FIG. 3 is a diagrammatic representation of a system 300 with a series of mixing reactors, a spray dryer, and a fluid catalytic cracking unit 350. This system for producing a modified HZSM-5 zeolite catalyst 348 includes a milling unit 302 equipped with milling elements, a first inlet, and a first outlet. The milling unit 302 milling elements are configured to produce a milled HZSM-5 zeolite powder 306 with particle size of less than 2 microns. The milling unit 302 first inlet has an opening to receive a HZSM-5 zeolite powder 304. The milling unit 302 first outlet is connected to a first mixing reactor 308. The first mixing reactor 308 is equipped with a second inlet, a third inlet, a fourth inlet, and a second outlet. The second inlet is connected to and in solids communication with the second outlet to receive the milled HZSM-5 zeolite powder 306. The first mixing reactor 308 has the third inlet to receive an aqueous alkaline solution 310. The first mixing reactor 308 has the fourth inlet to receive a first phosphatation agent 312. The first mixing reactor 308 has the second outlet in fluid communication with a fifth mixing reactor 338.

The system 300 further includes a second mixing reactor 320 equipped with a fifth inlet, a sixth inlet, and a third outlet. The second mixing reactor 320 has the fifth inlet to receive clay solids 316. The second mixing reactor 320 has the sixth inlet to receive deionized water 318. The second mixing reactor 320 has the third outlet connected to a fourth mixing reactor 332.

The system 300 further includes a third mixing reactor 328 equipped with a seventh inlet, an eighth inlet, and a fourth outlet. The third mixing reactor 328 has the seventh inlet to receive alumina solids 324. The third mixing reactor 328 has the eighth inlet to receive an aqueous acidic solution 326. The third mixing reactor 328 has the fourth outlet connected to the fourth mixing reactor 332. The fourth mixing reactor 332 is equipped with a ninth inlet, a tenth inlet, and a fifth outlet. The fourth mixing reactor 332 ninth inlet is connected to and in fluid communication with the third outlet to receive an aqueous clay slurry 322. The fourth mixing reactor 332 tenth inlet is connected to and in fluid communication with the fourth outlet to receive a dispersed alumina 330. The dispersed alumina 330 is a peptized pseudo boehmite, in certain embodiments. The fourth mixing reactor 332 has a fifth outlet connected to a fifth mixing reactor 338.

The system 300 further includes a fifth mixing reactor 338 equipped with an eleventh inlet, a twelfth inlet, and a sixth outlet. The fifth mixing reactor 338 has the eleventh inlet connected to and in fluid communication with both the second outlet to receive a 5 wt. % P₂O₅-AT-HZSM-5 zeolite 314, and the fifth outlet to receive a mixed binder slurry 334. The fifth mixing reactor 338 has a twelfth inlet to receive a second phosphatation agent 336. The fifth mixing reactor 338 has a sixth outlet in fluid communication with a sixth mixing reactor 342.

The system 300 further contains a sixth mixing reactor 342 equipped with an agitator including ultrasonication elements, a thirteenth inlet, and a seventh outlet. The sixth mixing reactor 342 thirteenth inlet is connected to and in fluid communication with the sixth outlet to receive a 10 wt. % P₂O₅-AT-HZSM-5 zeolite 340. The sixth mixing reactor 342 seventh outlet is connected to a spray dryer 346. The spray dryer 346 is equipped with spray drying elements, a fourteenth inlet, and an eighth outlet. The spray dryer 346 fourteenth inlet is connected to and fluid communication with the seventh outlet to receive a homogenized zeolite slurry 344. The spray dryer 346 eighth outlet has an opening to discharge a modified HZSM-5 zeolite catalyst 348.

The system 300 further contains a fluid catalytic cracking unit 350 equipped with a fifteenth inlet, a sixteenth inlet, and a ninth outlet. The fluid catalytic cracking unit 350 fifteenth inlet has an opening to receive the modified HZSM-5 zeolite catalyst 348. The fluid catalytic cracking unit 350 sixteenth inlet has an opening to receive a hydrocarbons stream 352, such as a stream of light hydrocarbons. The fluid catalytic cracking unit 350 ninth outlet has an opening to discharge a high value chemical product 354. More specifically, the present disclosure relates to systems and methods for producing a modified HZSM-5 catalyst for FCC applications where the catalyst has high activity, a low attrition rate and yields a high percentage of short chain olefins in the high value chemical product 354.

Examples describe or illustrate selected aspects of the various embodiments of a modified HZSM-5 catalyst for FCC applications to produce a high value chemical product from a hydrocarbon fluid, including various compositions of the hydrocarbon fluid as well as systems and methods of using the catalysts.

### EXAMPLES

The following examples are put forth so as to provide those of ordinary skill in the art with a complete disclosure and description of how the compounds, compositions, articles, devices and/or methods claimed herein are made and evaluated and, therefore, are intended to be purely exemplary and are not intended to limit the disclosure. Efforts have been made to ensure accuracy with respect to numbers (e.g., amounts, temperature, etc.), but some errors and deviations should be accounted for.

There are numerous variations and combinations of reaction conditions, for example, component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

### Example 1: Properties and Types of Suitable Hydrocarbon Fluids for FCC

The modified HZSM-5 catalyst disclosed herein may be used in FCC applications on one or more of a variety of suitable hydrocarbon fluids. For example, Table 1 displays certain properties of light straight run naphtha (LSRN) and full range naphtha (FRN).

TABLE 1
Properties of LSRN and FRN

| Feed Property | LSRN | FRN |
|---|---|---|
| °API Gravity | 82.6 | 70 |
| Density @ 15° C., g/ml | 0.6602 | 0.705 |
| Specific Gravity | 0.6608 | 0.71 |
| Refractive Index | 1.372 | 1.395 |
| Sulfur, ppmw | 0.5 | 50 |
| Total Nitrogen, ppmw | 0 | 1 |

Table 2 displays the mass percent total by group type and carbon number of LSRN.

TABLE 2
Mass percent total by group type and carbon number of LSRN

| Car- | n- | | | Naph- | | |
|---|---|---|---|---|---|---|
| bon | Paraffins | Isoparaffins | Olefins | thenes | Aromatics | Total |
| C4 | 0.034 | — | — | — | — | 0.034 |
| C5 | 27.45 | 9.8 | — | — | — | 37.25 |
| C6 | 22.3 | 25.77 | 0.105 | 4.9 | 1.171 | 54.246 |
| C7 | 1.87 | 5 | — | 0.9 | 0.14 | 7.91 |
| C8 | — | 0.443 | — | — | — | 0.443 |
| Total | 51.654 | 41.013 | 0.105 | 5.8 | 1.386 | 99.958 |

| | |
|---|---|
| Total Unknowns | 0.048 |
| Grand Total | 100.01 |

Table 3 displays the mass percent total by group type and carbon number of FRN.

TABLE 3
Mass percent total by group type and carbon number of FRN

| Car- | n- | | | Naph- | | |
|---|---|---|---|---|---|---|
| bon | Paraffins | Isoparaffins | Olefins | thenes | Aromatics | Total |
| C4 | 0.97 | 0.12 | — | — | — | 1.09 |
| C5 | 6.42 | 2.80 | — | — | — | 9.22 |
| C6 | 8.84 | 11.08 | 0.25 | 7.68 | 0.55 | 28.39 |
| C7 | 7.64 | 15.38 | 0.27 | 7.30 | 1.16 | 31.74 |
| C8 | 3.82 | 6.13 | 0.04 | 4.83 | 1.24 | 16.06 |
| C9 | 1.89 | 2.78 | 0.73 | 3.59 | 0.72 | 9.71 |
| C10 | 1.23 | 1.16 | — | 1.20 | 0.05 | 3.64 |
| C11 | 0.04 | 0.07 | — | 0.01 | — | 0.13 |
| C12 | 0.02 | — | — | — | — | 0.02 |
| C13 | 0.01 | — | — | — | — | 0.01 |
| Total | 30.87 | 39.53 | 1.28 | 24.61 | 3.71 | 100.00 |

| | |
|---|---|
| Total Heavies | 0.3 |
| Grand Total | 100.00 |

Table 4 displays the mass percent total by group type and carbon number of light naphthenic naphtha.

TABLE 4
Mass percent total by group type and carbon number of
light naphthenic naphtha

| Car- | n- | Iso- | | Naph- | | |
|---|---|---|---|---|---|---|
| bon | Paraffins | paraffins | Olefins | thenes | Aromatics | Total |
| C4 | 0.46 | 0.025 | 0.024 | — | — | 0.51 |
| C5 | 10.782 | 6.394 | — | — | — | 17.18 |
| C6 | 18.659 | 20.979 | 0.716 | 17.8316 | 5.325 | 63.51 |
| C7 | 2.955 | 10.475 | 0.215 | 4.475 | — | 18.12 |
| C8 | — | 0.108 | 0.563 | — | — | 0.67 |
| Total | 32.86 | 37.98 | 1.52 | 22.31 | 5.33 | 99.99 |

Table 5 displays the mass percent total by group type and carbon number of hydrocarbon feed type 4.

TABLE 5
Mass percent total by group type and carbon number of
hydrocarbon feed type 4

| Car- | n- | Iso- | | Naph- | | |
|---|---|---|---|---|---|---|
| bon | Paraffins | paraffins | Olefins | thenes | Aromatics | Total |
| C3 | 0.09 | — | — | — | — | 0.09 |
| C4 | 3.11 | 0.79 | 0.05 | — | — | 3.95 |
| C5 | 5.23 | 4.25 | — | 0.26 | — | 9.74 |
| C6 | 5.34 | 6.23 | — | 3.47 | 0.76 | 15.8 |
| C7 | 4.86 | 5.3 | 0.1 | 7.69 | 1.52 | 19.47 |
| C8 | 3.96 | 6.18 | 2.84 | 3.22 | 2.98 | 19.18 |
| C9 | 2.86 | 3.26 | 3.52 | 1.49 | 3.3 | 14.43 |
| C10 | 2.18 | 4.31 | 1 | 0.86 | 2.37 | 10.72 |
| C11 | 2.02 | 0.9 | 0.27 | — | 1.1 | 4.29 |
| C12 | 1.47 | 0.51 | — | — | 0.3 | 2.28 |
| Total | 31.12 | 31.73 | 7.78 | 16.99 | 12.33 | 99.95 |

| | |
|---|---|
| Dienes | 0.05 |
| Grand Total | 100 |

Table 6 displays the mass percent total by group type and carbon number of hydrocarbon feed type 5.

TABLE 6
Properties of hydrocarbon feed type 5

| Property | Value |
|---|---|
| °API Gravity | 55.80 |
| Density @ 15° C., g/ml | 0.75 |
| Specific Gravity | 0.76 |
| Refractive Index | 1.42 |
| Sulfur, ppmwt | 198.30 |
| Total Nitrogen, ppmwt | 9.60 |

### Example 2: Spray Drying HZSM-5, Ti-HZSM-5, and AT-HZSM-5 Zeolite Catalysts

As will be understood, spray drying zeolite catalysts may provide clear enhancements to their use in FCC. 600 g of HZSM-5 zeolite, 600 g of 2 wt. % Ti-HZSM-5 zeolite, and 600 g of AT-HZSM-5 zeolite, each on dry basis and having a having a HZSM-5 silica to alumina molar ratio of 30, were made into respective zeolite slurries with 1100 g of demineralized (DM) water. Each zeolite slurry (A) was stabilized at room temperature under continuous stirring for about 1 hour. 750 g of pseudo boehmite SCF grade alumina (on dry basis) was made into an alumina slurry (B) with 1668 g of DM water and peptized with 33.8 g of nitric acid (on dry basis), while kept under vigorous stirring for 1 hour. 525 g of Kaoline-100 clay (on dry basis) was made into a clay slurry (C) with 1575 g of DM water and kept under vigorous stirring for 1 hour. Then, each prepared zeolite slurry was mixed with a prepared alumina slurry and a prepared clay slurry for about 1 hour at 50° C. The pH of the mixed final slurry was 4.

Each final slurry was spray dried to form microsphere particles having an average particle size (APS) of 80-110 microns. Each spray dried product was calcined at 650° C. for 1 hour, producing SD-HZSM-5, SD-Ti/HZSM-5, and SD-AT-HZSM-5 that were each measured for ABD and attrition index (via ASTM-D5757). Table 7 displays the physical properties of catalysts SD-HZSM-5, SD-Ti/HZSM-5, and SD-AT-HZSM-5. It can be noted that an attrition index below 10 is acceptable, which is similar to large-scale FCC plant applications. Generally, an attrition index of more than 10 results in Power Recovery Turbine (PRT) vibrations and accrual of fines based on stack emissions of the FCC unit. As such, the SD-Ti/HZSM-5 is not evaluated in the subsequent test.

TABLE 7
Physical Properties of Spray Dried (SD) Catalysts

| Catalyst name | SD-HZSM-5 | SD-Ti/HZSM-5 | SD-AT-HZSM-5 |
|---|---|---|---|
| ABD, g/cc | 0.781 | 0.743 | 0.832 |
| Attrition Index (AI) | 8.5 | 11 | 8.3 |
| APS (μ) | 128 | 122 | 106 |

Once prepared, the remaining spray dried catalysts were each tested in a pilot riser having a long riser reactor (9 m×6.7 mm ID), a stripper section, a lift line, and a fluid bed regenerator (78 mm ID). Regenerated catalyst flow to an inlet of the reactor riser was controlled with a slide valve.

The catalysts were tested in isothermal conditions with a feed of LSRN, certain properties of which are displayed above in Tables 1 and 2. Typical operating conditions included: a riser temperature of 675° C., a regenerator temperature of 750° C., a feed rate of 4.6 g/min, a riser pressure of 38 psia (262 kPa), a carbon/oxygen rate (C/O) of 45, and a nitrogen stripping gas. Table 8 displays the product yields for both the SD-HZSM-5 and the SD-AT-HZSM-5. For these spray dried embodiments, SD-AT-HZSM-5 provides a slight increase in conversion and decrease in coking compared to the non-alkali treated catalyst, SD-HZSM-5.

TABLE 8
Product Yields of Spray Dried Catalysts with Modified HZSM-5

| Catalyst Name | SD-HZSM-5 | SD-AT-HZSM-5 |
|---|---|---|
| Conversion, wt. % | 60 | 65.5 |

Product Yields, wt. %

| | | |
|---|---|---|
| Coke | 0.86 | 0.71 |
| LCO | 0.68 | 0.3 |
| Hydrogen | 0.48 | 0.6 |
| Methane | 8.6 | 9.1 |
| Ethane | 6.8 | 8.5 |
| Ethylene | 13.7 | 14.2 |
| Propane | 2.9 | 4.9 |
| Propylene | 17.6 | 17.6 |
| iC4+ | 0.55 | 1 |
| nC4+ | 0.56 | 0.9 |
| iC4= | 3.00 | 3.15 |
| nC4= | 7.9 | 4.8 |
| Benzene | 3.19 | 2.92 |
| Toluene | 2.87 | 3.06 |
| Xylene | 2.29 | 2.28 |
| Gasoline | 30.62 | 25.46 |

### Example 3: Spray Drying Phosphorus Stabilized HZSM-5, Ti-HZSM-5, and AT-HZSM-5 Zeolite Catalysts

In certain cases, phosphorous stabilization of the zeolite catalysts affects the spray drying results. In this case, 600 g of 5 wt. % P₂O₅-HZSM-5, 5 wt. % P₂O₅-2 wt. % Ti-HZSM-5, and 5 wt. % P₂O₅-AT-HZSM-5, each on dry basis and having a having a HZSM-5 silica to alumina molar ratio of 30, were made into respective zeolite slurries with 1100 g of DM water. Each zeolite slurry (A) was stabilized at room temperature under continuous stirring for about 1 hour. 750 g of dispersal P2 grade alumina (on dry basis) was made into an alumina slurry (B) with 1668 g of DM water and peptized with 33.8 g of nitric acid (on dry basis), while kept under vigorous stirring for 1 hour. 525 g of Kaoline-100 clay (on dry basis) was made into a clay slurry (C) with 1575 g of DM water and kept under vigorous stirring for 1 hour. Then, each prepared zeolite slurry was mixed with a prepared alumina slurry and a prepared clay slurry for about 1 hour at 50° C. Additionally, a 2 wt. % aluminum chlorohydrate (ACH) was added. Each final slurry was spray dried to form microsphere particles having an APS of 80-110 microns. Each spray dried product was calcined at 650° C. for 1 hour, producing SD-P₂O₅-HZSM-5, SD-P₂O₅-Ti/HZSM-5, and SD-P₂O₅-AT-HZSM-5 that were each measured for ABD and attrition index. Table 9 displays the physical properties of the spray dried catalysts containing phosphate. The SD-P₂O₅-AT-HZSM-5 was not evaluated in the subsequent test based on its AI being greater than 10.

TABLE 9
Physical Properties of Spray Dried Catalysts Containing Phosphate

| | | SD-P₂O₅- | SD-P₂O₅-AT- |
|---|---|---|---|
| Catalyst Name | SD-P₂O₅-HZSM-5 | Ti/HZSM-5 | HZSM-5 |
| ABD, g/cc | 0.62 | 0.72 | 0.72 |
| Attrition Index (AI) | 6.7 | 9.8 | 16 |
| APS (μ) | 92 | 100 | 120 |

The remaining catalysts were tested via the equipment and the conditions described above in Example 2, including a feed of LSRN. Table 10 displays the product yields for both the SD-P₂O₅-HZSM-5 and the SD-P₂O₅-Ti/HZSM-5. As demonstrated, the SD-P₂O₅-HZSM-5 provided a higher conversion of the LSRN with less coking compared to the titanium treated SD-P₂O₅-Ti/HZSM-5.

TABLE 10
Product Yields of Spray Dried Catalysts with Phosphorus
Stabilized Modified HZSM-5

| Catalyst Name | SD-P₂O₅-HZSM-5 | SD-P₂O₅-Ti/HZSM-5 |
|---|---|---|
| Conversion, wt. % | 70 | 62.3 |

Product Yields, wt. %

| | | |
|---|---|---|
| Coke | 0.7 | 0.94 |
| LCO | 0.55 | 0.86 |
| Hydrogen | 0.7 | 0.58 |
| Methane | 8.8 | 8.42 |
| Ethane | 9.5 | 8.41 |
| Ethylene | 14.6 | 13.61 |
| Propane | 7.2 | 5.4 |
| Propylene | 17.12 | 16.33 |
| iC4+ | 1.2 | 0.71 |
| nC4+ | 1.2 | 0.80 |
| iC4= | 3.50 | 2.94 |
| nC4= | 5.3 | 4.6 |
| Benzene | 4.64 | 4.67 |
| Toluene | 5.59 | 5.35 |
| Xylene | 4.24 | 3.62 |
| Gasoline | 14.65 | 22.44 |

### Example 4: Effect of Spray Drying Slurry Preparation for Second Phosphate Treated AT-HZSM-5

600 g of AT-HZSM-5, on dry basis and having a HZSM-5 silica to alumina molar ratio of 30, was made into a zeolite slurry with 1100 g of DM water. 121.6 g of monoammonium phosphate was dissolved in 360 g of DM water and mixed with the zeolite slurry to make a zeolite phosphate slurry (A). The zeolite phosphate slurry was stabilized at room temperature under continuous stirring for about 3 hours. 660 g of dispersal P2 grade alumina (on dry basis) was made into an alumina slurry (B) with 11466.7 g of DM water and peptized with 29.7 g of nitric acid (on dry basis), while kept under vigorous stirring for 3 hours. 420 g of Kaoline-100 clay (on dry basis) was made into a clay slurry (C) with 1260 g of DM water and kept under vigorous stirring for 3 hours.

Additionally, 97.3 g of monoammonium phosphate (MAP) was made into a phosphate solution (D) with 292 g of DM water under vigorous stirring for 1 hour. Then, the prepared alumina slurry (B), clay slurry (C), and phosphate solution (D) were mixed under vigorous stirring, while maintaining the pH above 3.5. The zeolite phosphate slurry (A) was added to the alumina, clay, and phosphate slurry under continuous stirring for about 1 hour at 50° C. Additionally, 28 g of ACH was added. After the second phosphate treatment, the final slurry was spray dried to form microsphere particles having an APS of 80-110 microns. The spray dried product was calcined at 650° C. for 1 hour and measured for ABD and attrition index. The resulting product was a spray dried, second phosphate treated AT-HZSM-5 (2^{nd} SD-P₂O₅-AT-HZSM-5). Table 11 displays the physical properties of the 2^{nd} SD-P₂O₅-AT-HZSM-5 compared to the 1^{st} SD-P₂O₅-AT-HZSM-5 having a single phosphate treatment discussed above, as well as a 3^{rd} SD-P₂O₅-AT-HZSM-5 discussed below.

TABLE 11
Physical Properties of Phosphate Containing Spray Dried Catalysts

| | 1^{st} SD-P₂O₅-AT- | 2^{nd} SD-P₂O₅-AT- | 3^{rd} SD-P₂O₅-AT- |
|---|---|---|---|
| Catalyst Name | HZSM-5 | HZSM-5 | HZSM-5 |
| ABD, g/cc | 0.72 | 0.62 | 0.67 |
| Attrition Index | 16 | 9.8 | 5.7 |
| (AI) | | | |
| APS (μ) | 120 | 100 | 89 |

### Example 5: Effect of Active Component Percentage for Second Phosphate Treated AT-HZSM-5

450 g of AT-HZSM-5, on dry basis and having a HZSM-5 silica to alumina molar ratio of 30, was made into a zeolite slurry with 749 g of DM water. 121.56 g of monoammonium phosphate dissolved in 200 g of DM water and mixed with the zeolite slurry to make a zeolite phosphate slurry (A). The zeolite phosphate slurry was stabilized at room temperature under continuous stirring for about 3 hours. 750 g of dispersal P2 grade alumina (on dry basis) was made into an alumina slurry (B) with 11466.7 g of DM water and peptized with 22.5 g of nitric acid (on dry basis), while kept under vigorous stirring for 3 hours. 525 g of Kaoline-100 clay (on dry basis) was made into a clay slurry (C) with 1260 g of DM water and kept under vigorous stirring for 3 hours.

Additionally, 121.5 g of MAP was made into a phosphate solution (D) with 200 g of DM water under vigorous stirring for 1 hour. It should be noted that this phosphate solution had a higher concentration than the phosphate solution of Example 4 above. Then, the prepared alumina slurry (B), clay slurry (C), and phosphate solution (D) were mixed under continuous stirring, while maintaining the pH around 3.5. The pH of mixed slurry was 3.5. The zeolite phosphate slurry was added to the alumina, clay, and phosphate slurry to mix fully, as well as ultrasonicated for about 1 hour. The final slurry was heated to 50° C. and then spray dried to form microsphere particles having an APS of 80-110 microns. The spray dried product was calcined at 650° C. for 1 hour and measured for ABD and attrition index. The resulting product was a spray dried, second phosphate treated AT-HZSM-5 (3^{rd} SD-P₂O₅-AT-HZSM-5), which includes a higher active component percentage than the catalyst of Example 4 (2^{nd} SD-P₂O₅-AT-HZSM-5). Table 11 above includes the physical properties of the 3^{rd} SD-P₂O₅-AT-HZSM-5.

Moreover, the 3^{rd} SD-P₂O₅-AT-HZSM-5 was hydrothermally deactivated separately, at 750° C. for 12 hours using 100% steam at atmospheric pressure, to form a steamed 3^{rd} SD-P₂O₅-AT-HZSM-5.

The activity of the 2^{nd} SD-P₂O₅-AT-HZSM-5, 3^{rd} SD-P₂O₅-AT-HZSM-5, and steamed 3^{rd} SD-P₂O₅-AT-HZSM-5 were evaluated via the equipment and the conditions described above in Example 2, including a feed of LSRN. Table 12 displays the product yields for each of these catalysts.

TABLE 12
Product Yields of 2^{nd} SD-P₂O₅-AT-HZSM-5, 3^{rd}
SD-P₂O₅-AT-HZSM-5, and steamed 3^{rd} SD-P₂O₅-AT-HZSM-5

| | 2^{nd} SD- | 3^{rd} SD- | Steamed |
|---|---|---|---|
| | P₂O₅-AT- | P₂O₅-AT- | SD-P₂O₅-AT- |
| Catalyst Name | HZSM-5 | HZSM-5 | HZSM-5 |
| HZSM-5, | 40 | 30 | 30 |
| wt. % | | | |
| Conversion, | 68.32 | 70.59 | 61.73 |
| wt. % | | | |

Product Yields, wt. %

| | | | |
|---|---|---|---|
| Coke | 0.8 | 1.52 | 1.32 |
| LCO | 0.42 | 0.8 | 0.34 |
| Hydrogen | 0.68 | 0.92 | 0.44 |
| Methane | 8.47 | 10.14 | 8.55 |
| Ethane | 9.49 | 11.31 | 6.98 |
| Ethylene | 14.48 | 13.67 | 14.33 |
| Propane | 6.35 | 8.74 | 3.38 |
| Propylene | 17.17 | 14.58 | 17.45 |
| iC4+ | 1.1 | 1.31 | 0.5 |
| nC4+ | 1.21 | 1.14 | 0.6 |
| iC4= | 3.46 | 3.00 | 3.05 |
| nC4= | 5.13 | 4.35 | 5.09 |
| Benzene | 3.54 | 2.99 | 3.45 |
| Toluene | 5.03 | 7.76 | 3.14 |
| Xylene | 3.65 | 6.36 | 2.37 |
| Gasoline | 18.86 | 10.75 | 28.84 |

As indicated, the 3rd SD-P₂O₅-AT-HZSM-5 having the higher active component percentage (and lower HZSM-5 wt. %) provided a conversion wt. % f more than 70. Further, the 3^{rd} SD-P₂O₅-AT-HZSM-5 and a reference catalyst were also hydrothermally deactivated separately at 750° C. for 12 hours using 100% steam at atmospheric pressure, to form a steamed reference catalyst. Activity of the steamed 3^{rd} SD-P₂O₅-AT-HZSM-5 and steamed reference catalyst were evaluated in a circulated riser unit at isothermal conditions with a feed of LSRN. Typical operating conditions included: a riser temperature of 675° C., a regenerator temperature of 750° C., a feed rate of 10 g/min, a riser pressure of 38 psia (262 kPa), a carbon/oxygen rate (C/O) of 30, and a nitrogen stripping gas. Table 13 displays the product yields for the steamed 3^{rd} SD-P₂O₅-AT-HZSM-5 and steamed reference catalyst.

TABLE 13
Product Yields of Steamed 3^{rd} SD-P₂O₅-AT-HZSM-5
and Steamed Reference

| | Steamed 3^{rd} SD- | Steamed |
|---|---|---|
| Catalyst Name | P2O5-AT-ZSM-5 | Reference |
| Conversion (LPG + | 58.57 | 53.71 |
| DRY + COKE), wt. % | | |

Product Yields, wt. %

| | | |
|---|---|---|
| Coke | 0.76 | 0.16 |
| LCO | 0.30 | 0.22 |
| H2 | 0.40 | 0.37 |
| H2S | 0.00 | 0.00 |
| CH4 | 6.54 | 6.54 |
| C2+ | 6.93 | 6.00 |
| C2= | 12.74 | 12.08 |
| C3+ | 4.75 | 2.84 |
| C3= | 16.41 | 16.49 |
| iC4+ | 0.80 | 0.32 |
| nC4+ | 0.91 | 0.63 |
| iC4= | 2.87 | 2.82 |
| nC4= | 5.42 | 5.38 |
| C4 == | 0.04 | 0.09 |
| DCO | 0.03 | 0.04 |
| BTX | 6.64 | 5.30 |
| Gasoline | 34.45 | 40.73 |

Other objects, features and advantages of the disclosure will become apparent from the foregoing figures, detailed description, and examples. It should be understood, however, that the figures, detailed description, and examples, while indicating specific embodiments of the disclosure, are given by way of illustration only and are not meant to be limiting. Additionally, it is contemplated that changes and modifications within the spirit and scope of the disclosure will become apparent to those skilled in the art from the detailed description. In further embodiments, features from specific embodiments may be combined with features from other embodiments. For example, features from one embodiment may be combined with features from any of the other embodiments. In further embodiments, additional features may be added to the specific embodiments described herein.

1. A method of preparing a modified HZSM-5 zeolite catalyst, the method comprising:
introducing a first phosphate treated alkali treated HZSM-5 (AT-HZSM-5) zeolite to a mixture of an aqueous clay slurry and an alumina dispersion to produce a mixed zeolite binder slurry, wherein the first phosphate treated AT-HZSM-5 zeolite contains about 5 weight percent of phosphorous pentoxide;
adding a phosphatation agent in a predetermined amount to the mixed zeolite binder slurry to produce a second phosphate treated AT-HZSM-5 zeolite containing about 10 weight percent of phosphorous pentoxide;
agitating the second phosphate treated AT-HZSM-5 zeolite to produce a homogenized zeolite slurry; and
passing the homogenized zeolite slurry through a spray dryer to produce spherical particles of the modified HZSM-5 zeolite catalyst.

2. The method of claim 1, wherein the phosphatation agent comprises a second phosphatation agent, the predetermined amount comprises a second predetermined amount, and wherein the method further comprising the steps of:
introducing a HZSM-5 zeolite to a milling unit to produce a milled HZSM-5 zeolite with a particle size of less than about 2 microns;
introducing the milled HZSM-5 zeolite to an aqueous alkaline solution to make the AT-HZSM-5 zeolite; and
adding a first phosphatation agent in a first predetermined amount to the AT-HZSM-5 zeolite to produce the first phosphate treated AT-HZSM-5 zeolite.

3. The method of any one of claims 1 or 2, further comprising the step of:
calcining the first phosphate treated AT-HZSM-5 zeolite for a period ranging from about 30 minutes to about 10 hours at a temperature ranging from about 300° C. to about 650° C.

4. The method of claim 3, wherein the aqueous alkaline solution contains one or more of a potassium hydroxide, a lithium hydroxide, or a sodium hydroxide.

5. The method of any one of claims 1-4, wherein the phosphatation agent is one or more of a phosphoric acid, a monoammonium phosphate, an ammonium hydrogen phosphate, or an ammonium phosphate.

6. The method of any one of claims 1-5, wherein the aqueous clay slurry contains a clay, the clay being one or more of a kaolin, a halloysite, a montmorillonite, a diatomite, an attapulgite, a sepiolite, a hydrotalcite, a rectorite, or a bentonite.

7. The method of any one of claims 1-6, further comprising the step of:
calcining the second phosphate treated AT-HZSM-5 zeolite for a period ranging from about 30 minutes to about 10 hours at a temperature ranging from about 300° C. to about 650° C.;
calcining the modified HZSM-5 zeolite catalyst for a period ranging from about 30 minutes to about 10 hours at a temperature ranging from about 300° C. to about 650° C.;
or both.

8. The method of any one of claims 1-7, wherein the alumina dispersion is prepared by treating an alumina with an aqueous nitric acid, an aqueous acetic acid, or an aqueous formic acid solution for about three hours to disperse the alumina in a water phase, the alumina being one or more of pseudo boehmite, pseudo boehmite SCF, dispersal alumina, or alumina sol.

9. The method of any one of claims 1-8, wherein the step of agitating the second phosphate treated AT-HZSM-5 zeolite includes ultrasonication for a period of about 30 minutes.

10. The method of any one of claims 1-9, wherein the modified HZSM-5 zeolite catalyst has a particle size distribution centered between about 60 microns to about 120 microns and a bulk density ranging from about 0.7 g/ml to about 0.95 g/ml.

11. A method of preparing a high value chemical product using a modified HZSM-5 zeolite catalyst, the method comprising:
supplying the modified HZSM-5 zeolite catalyst to a cracking unit, the modified HZSM-5 zeolite catalyst being prepared by the method of claim 1;
introducing a hydrocarbon fluid to the modified HZSM-5 zeolite catalyst in the cracking unit, the hydrocarbon fluid containing one or more hydrocarbons, each hydrocarbon of the one or more hydrocarbons containing less than about 24 carbon atoms and having a boiling point of less than about 330° C.;
causing catalytic cracking of the one or more hydrocarbons in the hydrocarbon fluid to produce a hydrocarbon product stream containing a plurality of alkene hydrocarbons and aromatics, the plurality of alkene hydrocarbons and aromatics containing less than about 10 carbon atoms; and
supplying the hydrocarbon product stream to a separator to produce the high value chemical product, the high value chemical product being one or more of an ethylene, a propylene, a butene, a benzene, a toluene, and a xylene.

12. The method of claim 11, further comprising the step of:
separating the hydrocarbon product stream by distillation to produce the high value chemical product.

13. The method of any one of claims 11 or 12, wherein the modified HZSM-5 zeolite catalyst has a particle size distribution centered between about 60 microns to about 120 microns and a bulk density of between about 0.70 g/ml to about 0.95 g/ml.

14. A system of preparing a high value chemical product using a modified HZSM-5 zeolite catalyst, the system comprising:
a milling unit equipped to receive a HZSM-5 zeolite powder and operated to produce a milled HZSM-5 zeolite powder with a particle size of less than about 2 microns;
a first mixing unit equipped to receive the milled HZSM-5 zeolite powder, an aqueous alkaline solution, and a first phosphatation agent in a first predetermined amount, the first mixing unit being operated to mix the milled HZSM-5 zeolite powder, the aqueous alkaline solution, and the first phosphatation agent to produce a first phosphate treated AT-HZSM-5 zeolite containing about 5 weight percent of phosphorous pentoxide;
a second mixing unit equipped to receive a clay powder and a deionized water and operated to mix the clay powder and the deionized water to produce an aqueous clay slurry;
a third mixing unit equipped to receive an alumina powder and an aqueous acidic solution and operated to mix the alumina powder and the aqueous acidic solution to produce an alumina dispersion;
a fourth mixing unit equipped to receive the clay slurry and the alumina dispersion and operated to mix the clay slurry and the alumina dispersion to produce a mixed binder slurry;
a fifth mixing unit equipped to receive the first phosphate treated AT-HZSM-5 zeolite, the mixed binder slurry, and a second phosphatation agent in a second predetermined amount, the fifth mixing unit being operated to mix the first phosphate treated AT-HZSM-5 zeolite, the mixed binder slurry, and the second phosphatation agent to produce a second phosphate treated AT-HZSM-5 zeolite containing about 10 weight percent of phosphorous pentoxide;
a sixth mixing unit equipped with an agitator to receive the second phosphate treated AT-HZSM-5 zeolite and operated to produce a homogenized zeolite slurry;
a spray dryer equipped to receive the homogenized zeolite slurry and operated to produce spherical particles of a modified HZSM-5 zeolite catalyst; and
a fluid catalyst cracking unit equipped to receive the modified HZSM-5 zeolite catalyst from the spray dryer and a hydrocarbon fluid containing a plurality of hydrocarbons to produce a high value chemical product containing ethylene, propylene, butene, benzene, toluene, and xylene, each hydrocarbon of the plurality of hydrocarbons containing less than about 24 carbon atoms.

15. The system of claim 14, wherein the aqueous alkaline solution is a potassium hydroxide, a lithium hydroxide, or a sodium hydroxide.

16. The system of any one of claims 14 or 15, wherein the first phosphatation agent, the second phosphatation agent, or a combination thereof is one or more of a phosphoric acid, a monoammonium phosphate, an ammonium hydrogen phosphate, or an ammonium phosphate.

17. The system of any one of claims 14-16, wherein the clay powder is one or more of a kaolin, a halloysite, a montmorillonite, a diatomite, an attapulgite, a sepiolite, a hydrotalcite, a rectorite, or a bentonite.

18. The system of any one of claims 14-16, wherein the modified HZSM-5 zeolite catalyst has a particle size distribution centered between about 60 microns to about 120 microns and a bulk density of between about 0.7 g/ml to about 0.95 g/ml.

19. The system of any one of claims 14-16, wherein each hydrocarbon of the plurality of hydrocarbons has a boiling point of less than about 330° C.

20. A fluid catalytic cracking catalyst, comprising:
a mesoporous HZSM-5 zeolite in an amount ranging from about 20 wt. % to about 55 wt. % f the fluid catalytic cracking catalyst, the mesoporous HZSM-5 zeolite containing about 10 wt. % f phosphorous pentoxide;
a phosphorous oxide in an amount ranging from about 5 wt. % to about 15 wt. % P₂O₅ of the fluid catalytic cracking catalyst;
an alumina binder in an amount ranging from about 20 wt. % to about 30 wt. % f the fluid catalytic cracking catalyst;
a clay in an amount ranging from about 30 wt. % to about 40 wt. % f the fluid catalytic cracking catalyst; and
a sodium ion in an amount greater than about 0.1 wt. % f the fluid catalytic cracking catalyst.
